(19) United States
(12) Patent Application Publication
(10) Pub. No.: US 2025/0071588 A1
(43) Pub. Date: Feb. 27, 2025

(54) USER EQUIPMENT AND PROCESS FOR IMPLEMENTING CONTROL IN SET OF USER EQUIPMENT

(71) Applicant: MITSUBISHI ELECTRIC CORPORATION, TOKYO (JP)

(72) Inventors: VINCENT CORLAY, RENNES Cedex 7 (FR); ARNAUD BOUTTIER, RENNES Cedex 7 (FR)

(73) Assignee: MITSUBISHI ELECTRIC CORPORATION, TOKYO (JP)

(21) Appl. No.: 18/726,083

(22) PCT Filed: Jul. 11, 2022
(86) PCT No.: PCT/JP2022/027783

§ 371 Date: Jul. 1, 2024

(30) Foreign Application Priority Data
Feb. 9, 2022 (EP) 22305138.4

(51) Int. Cl. H04W 24/10; H04W 16/22

(52) U.S. Cl. CPC H04W 24/10; H04W 16/22

(57) ABSTRACT

A user equipment for implementing a control in a set of user equipments is provided with a model improvement module. Said model improvement module is dedicated to updating a prediction model that is used for inferring state predictions. The model improvement module alternates between a training mode where it determines a new prediction model to be implemented next, and an idle mode. A trade-off is obtained between limited resource requirement and accuracy of a state knowledge. In the idle mode, the model improvement module may assess a validity of the prediction model currently used.

### TECHNICAL FIELD

The invention relates to a user equipment that is adapted for implementing a control in a set of user equipments. It also relates to a corresponding process and set of user equipments. The invention has numerous applications, in particular in the context of the internet of things.

### BACKGROUND ART

There are systems comprised of several user equipments, where each of the user equipments determines its own state based on measurements of at least one of the other user equipments. In this way, a knowledge of the respective states of several or all user equipments is progressively built and continuously updated, which allows controlling the operation of one, some or all the user equipments in a consistent manner. When several of the user equipments are controlled, their control may be intended to achieve a global mission, and in such case referred to as distributed control.

One example of such applications is the in-flight control of a set of several unmanned aerial vehicles, also known as flying drones, for instance when these drones are intended to adopt prescribed relative positions. But many other applications exist, and the state definition to be considered for each user equipment for implementing the control may vary depending on each application. For the application to drones, each drone constitutes a separate user equipment, and its state is comprised of its in-space position as such position may be measured by a positioning system. Many other applications may benefit from control based on measurements related to several of the user equipments, as for instance network synchronisation. For this latter application, radio devices are the user equipments and their states are respective reference times.

In such system, each user equipment updates repetitively its own state based on a knowledge of the states of several other user equipments, also possibly based on the knowledge of the state of only one other user equipment. A better precision is provided by such control system in the determination of the respective states of the user equipments, compared to separate individual determinations of the states of the user equipments. To this end, each user equipment needs to obtain successive measurements of the states of some of the other user equipments, possibly including measurements of its own state but not necessarily. But practically and because of many reasons, one or several of the state measurements that are required for updating the state of one of the user equipments is/are not available at the time of performing the update. To avoid blocking the state updating process or simply improving its accuracy, the state measurements are supplemented with state predictions within the user equipment that is currently updating its own state. Each state prediction is based on prior state measurements that are available within the user equipment performing the state update, and a prediction model issues the state predictions from the prior state measurements. Then, a respective state estimate is determined for each of the user equipments that is used for performing the update, based on the state measurements and state predictions obtained for them. The state update is then determined from these estimates. Instead of implementing the prediction model with the prior state measurements, it is possible to implement it based on statistics that are derived from these prior state measurements.

In a known manner, a user equipment which is adapted for implementing a control in a set of user equipments, where the user equipment considered updates its own state based on state measurements and state predictions obtained for a subset of the user equipments, comprises:
storage means, which are adapted for storing at least some of the state measurements obtained for each user equipment of the subset, or for storing statistics that are derived from these state measurements obtained for each user equipment of the subset;
a prediction module, which is adapted for inferring a state prediction for any of the user equipments of the subset, by implementing a prediction model with state measurements or statistics recovered from the storage means;
a state estimation module, which is adapted for issuing a state estimate for each of the user equipments of the subset, by combining the state measurements and the state predictions of the user equipments of the subset;
a resource control module, adapted for selecting configuration parameters intended to control an operation of resources of the user equipments based on the state estimates issued by the state estimation module; and
a state control module, adapted for updating the state of the user equipment considered, also based on the state estimates issued by the state estimation module.

The state measurements may be obtained internally to the user equipment considered, for example when it includes an appropriate measurement module for measuring the state(s) of one or several of the other user equipments. Alternatively, the state measurements may be received via communication by the user equipment considered from any external appropriate means, including measurement means which are on-board each user equipment and suitable for measuring the respective state of this user equipment.

In case statistics are stored in the storage means, these statistics may have been provided by the state estimation module at an earlier time.

Such architecture of the user equipment is shown in FIG. 1, where the reference numbers have the following meanings:
1, 2, 3, 4 four user equipments
10 resources assigned to the user equipments, possibly including communication resources of wireless type
13 the storage means as mentioned above, for the user equipment 1
14 the prediction module of the user equipment 1
15 the state estimation module of the user equipment 1
16 the resource control module of the user equipment 1
17 the state control module of the user equipment 1.

In the example represented, the user equipment 1 receives state measurements from the user equipments 2 and 3, but not from the user equipment 4. yₖ¹, yₖ², and yₖ³ thus denote the state measurements obtained for time k and for user equipments 1, 2 and 3 respectively. These state measurements are fed into the state estimation module 15. Prior state measurements obtained before time k for the user equipments 1, 2 and 3 are stored in the storage means 13 and fed into the prediction module 14 for this latter to infer state predictions relating to time k and user equipments 1, 2 and 3. It is repeated that using within the user equipment 1 state measurements and predictions relating to this user equipment 1 is possible but not compulsory.

Xₖ¹, Xₖ², and Xₖ³ denote the state estimates issued for time k for the user equipments 1, 2 and 3, respectively, by the state estimation module 15. These state estimates are obtained by combining in a well-known manner the state measurements and state predictions which relate to time k.

The resource control module 16 may be a communication control module when the configuration parameters are intended to control communication resources that are implemented between the user equipments.

Possibly, for selecting the configuration parameters, the resource control module 16 may also take into account requirements issued by the state control module 17, for example when the states of the user equipments are varying rapidly.

Finally, x₁^{k} and xₖ₊₁¹ denote the true states of user equipment 1 for times k and k+1, respectively. The state xₖ₊₁¹ is obtained after the action of the state control module 17 by modifying the state x′k via other inputs such as activation of actuators of the user equipment 1, external instruction commands, etc. Possibly, the state control module 17 of the user equipment 1 may operate in a coordinated manner with the other user equipments, so as to form a distributed control system.

For such control operations, the accuracy of the state which is produced by the state control module 17 highly depends on the accuracy of the state measurements and state predictions that are used. In addition, the accuracy of each state prediction depends on both the measurements that are inputted into the prediction model, and the validity of the prediction model used. However, a prediction model which is valid at one time may no longer be valid later. Due to such limited validity of the prediction model, the state predictions may be less accurate.

The state measurements, i.e. yₖ¹, yₖ², and y₃^{k} in FIG. 1, can be more accurate, and thus more reliable, if they are each obtained from several basic state measurements all relating to time k. To this purpose, the collection frequency of the basic state measurements should be higher that the state update frequency, and the state measurements that are inputted into the state estimation module 15 and storage means 13 for time k are each an average of the basic state measurements relating to same time k. Such average is computed by the average calculation module 12 from the basic state measurements received by the user equipment 1 or provided by its internal measurement module 11 if any.

In the frame of the present description, the prediction model which is implemented by the prediction module 14 may perform a joint estimation of the states of the user equipments of the subset, i.e. the user equipments 1, 2 and 3 in the example of FIG. 1, or be comprised of individual models that relate separately to the user equipments of the subset.

The article entitled “Reinforcement Learning-Based Control and Networking Co-Designs for Industrial Internet of Things”, by H. Xu et al., IEEE Journal on Selected Areas in Communications, Vol. 38, No. 5, May 2020, discloses training the communication control module, i.e. module 16 in FIG. 1, through reinforcement learning so that it takes the optimal decision given the current state of the system. The optimal decision consists in recovering a maximum number of basic state measurements while avoiding congestion, in particular congestion of the measurement means or of communication means that connect the user equipments to one another for transmitting the state measurements.

Starting from this situation, one object of the present invention consists in improving the accuracy of the state estimates which are determined by a user equipment for implementing a control, while reducing a resource requirement.

A subsidiary object of the invention is that such improvement can be implemented from an already existing user equipment architecture.

### SUMMARY OF INVENTION

For meeting these objects or others, a first aspect of the present invention proposes a user equipment which comprises in addition to the storage means, prediction module, state estimation module, resource control module and state control module as recited above:
a model improvement module, which is adapted for implementing alternately a training mode and an idle mode.

In the training mode, the model improvement module determines the prediction model to be implemented next by the prediction module, from the state measurements or statistics that are obtained for the user equipments of the subset, or from the state estimates that are issued by the state estimation module.

The model improvement module is furthermore configured for injecting the prediction model as determined in the training mode into the prediction module. In this way, the injected prediction model is used by the prediction module when the model improvement module is in the idle mode.

According to another feature of the invention, the model improvement module is further adapted to control the resource control module for adjusting a reliability of the state measurements obtained for each user equipment of the subset at a level during a time period dedicated to the training mode higher than another level of this reliability that is effective during a prior or subsequent time period dedicated to the idle mode.

Thus, the control implementation requires less resources during the time periods dedicated to the idle mode, while providing state predictions which are reliable enough. This reliability of the state predictions is provided by the training mode, where the prediction model is trained using more resources. In this way, the prediction models which are used successively by the prediction module are more reliable, thus improving the quality of the state estimates which are issued by the state estimation module. The invention provides in this way an improved trade-off between resource requirements and accuracy of the state estimations which are used by the state control module.

Possibly, in the idle mode, the model improvement module may assess a validity of the prediction model which is currently implemented by the prediction module, as this prediction model has been previously determined by the model improvement module during the time period dedicated to the training mode.

In possible embodiments of the invention, the resources may be adapted to allow improving an accuracy of each state measurement as issued directly by state measurement means which are used. In such case, the state measurement accuracy provides the reliability of the state measurements.

In other possible embodiments of the invention, each state measurement of any user equipment of the subset, as stored by the storage means or used by the state estimation module, may be obtained from one or several basic state measurements relating to the same user equipment. Then, the model improvement module may be further adapted to control the resource control module for adjusting a frequency of the basic state measurements that are obtained for each user equipment of the subset, so that a value of this frequency during the time period dedicated to the training mode is higher than another value of the frequency that is effective during the prior or subsequent time period dedicated to the idle mode. In such embodiments of the invention, the reliability of the state measurements is improved by increasing the number of the basic state measurements that result in one state measurement.

For some applications of the invention, one or several of the following additional features may be implemented advantageously:
the user equipment may be adapted for communicating with the other ones by implementing a wireless communication mode, and for receiving wirelessly the state measurements or basic state measurements of at least one of the user equipments of the subset. Then, the resources of the set of user equipments may comprise radio-communication resources;
the user equipment may be adapted so that the state of any of the user equipments of the subset comprises coordinate values of a position of the user equipment of the subset. In such case, the user equipment may be further adapted for operating with the basic state measurements being provided by at least one positioning system. The basic state measurements for each user equipment of the subset may be then transmitted wirelessly between the user equipments or internally to each user equipment;
the model improvement module may be adapted to switch from the training mode to the idle mode once a matching criterion of the training mode is met by the prediction model that is currently being determined, between the state measurements and the state predictions inferred using this prediction model that is currently being determined, or after a request to free some resources has been received by the user equipment, or at a time issued by a scheduling algorithm;
the model improvement module may be adapted to switch back from the idle mode to the training mode when at least one of the following conditions occurs:
a matching criterion of the idle mode is no longer met between the state measurements and the state predictions as issued by the prediction module,
after receiving an indication that an amount of the resources is available,
after receiving an indication that the reliability of the state measurements is above a predetermined threshold, and at a time issued by the scheduling algorithm; and
the configuration parameters, that are selected by the resource control module based on the state estimates issued by the state estimation module, and possibly also based on requirements from the state control module, may be suitable for controlling at least one of a frequency of the basic state measurements, a transmission frequency of these basic state measurements, modulation and coding schemes, and at least one transmission power implemented between the user equipments.

A second aspect of the invention proposes a process for implementing a control in a set of user equipments, where each user equipment updates its own state based on state measurements and state predictions obtained for a subset of the user equipments. To this purpose, each user equipment performs the following steps:
storing at least some of the state measurements obtained for each user equipment of the subset, or storing statistics derived from these state measurements obtained for each user equipment of the subset;
inferring a state prediction for any of the user equipments of the subset, by implementing a prediction model with state measurements or statistics which have been stored previously;
issuing a respective estimate of the state for each of the user equipments of the subset, by combining the state measurements and state predictions of the user equipments of the subset;
selecting configuration parameters intended to control an operation of the resources of the user equipments, based on the state estimates; and
updating a state of the user equipment, also based on the state estimates.

According to the invention, at least one of the user equipments, referred to as model improvement user equipment, operates alternately in a training mode and an idle mode.

In the training mode, the prediction model is determined from the state measurements or statistics that are obtained for each user equipment of the subset, or from the state estimates issued for each user equipment of the subset.

The process then furthermore comprises updating the prediction model which is implemented for inferring the state predictions, according to the prediction model as determined in the training mode.

In addition, the configuration parameters are adjusted so that a reliability of the state measurements obtained for each user equipment of the subset is at a level during a time period dedicated to the training mode higher than another level of this reliability that is effective during a prior or subsequent time period dedicated to the idle mode.

Possibly, in the idle mode, a validity of the prediction model which is currently implemented may be assessed, as this prediction model has been previously determined during the time period dedicated to the training mode.

In possible implementations of the invention, for any of the user equipments of the subset, each state measurement stored or used for issuing one of the state estimates may be obtained from one or several basic state measurements. Then, a frequency of the basic state measurements that are obtained for each user equipment of the subset may be adjusted so that a value of this frequency during the time period dedicated to the training mode is higher than another value of the frequency that is effective during the prior or subsequent time period dedicated to the idle mode.

The model improvement user equipment may be in accordance with the first invention aspect.

In a similar manner to the first invention aspect, the following features may be implemented for the process of the second invention aspect:
the state measurements or basic state measurements may be transmitted wirelessly to the model improvement user equipment by at least one of the user equipments of the subset;
the state of any of the user equipments of the subset may comprise coordinate values of a position of this user equipment of the subset. In such case, the basic state measurements may be provided by at least one positioning system, and the basic state measurements for each user equipment of the subset may be then transmitted to the model improvement user equipment wirelessly or internally to the model improvement user equipment;
the model improvement user equipment may switch from the training mode to the idle mode once a matching criterion of the training mode is met by the prediction model that is currently being determined, between the state measurements and the state predictions inferred using this prediction model, or after a request to free some resources has been received by the model improvement user equipment, or at a time issued by a scheduling algorithm;
the model improvement user equipment may switch back from the idle mode to the training mode when at least one of the following conditions occurs:
a matching criterion of the idle mode is no longer met between the state measurements and the state predictions as used for issuing the state estimates,
after receiving an indication that an amount of the resources is available,
after receiving an indication that the reliability of the state measurements is above a predetermined threshold, and at a time issued by the scheduling algorithm; and
the configuration parameters may be selected based on the state estimates, and possibly also based on control requirements, for controlling at least one of a frequency of the basic state measurements, a transmission frequency of these basic state measurements, modulation and coding schemes, and at least one transmission power implemented between the user equipments.

Finally, a third aspect of the invention proposes a set of user equipments that are adapted to implement a control, wherein at least one of these user equipments is in accordance with the first invention aspect.

These and other features of the invention will be now described with reference to the appended figures, which relate to preferred but not-limiting embodiments of the invention.

### BRIEF DESCRIPTION OF DRAWINGS

FIG. 1 illustrates an architecture of a user equipment suitable for implementing a control, as known before the present invention.

FIG. 2 illustrates a possible application of the invention.

FIG. 3 corresponds to FIG. 1 for a user equipment that is in accordance with the present invention.

FIG. 4 illustrates schematically a prediction model which may be implemented in the user equipment of FIG. 3.

### DESCRIPTION OF EMBODIMENTS

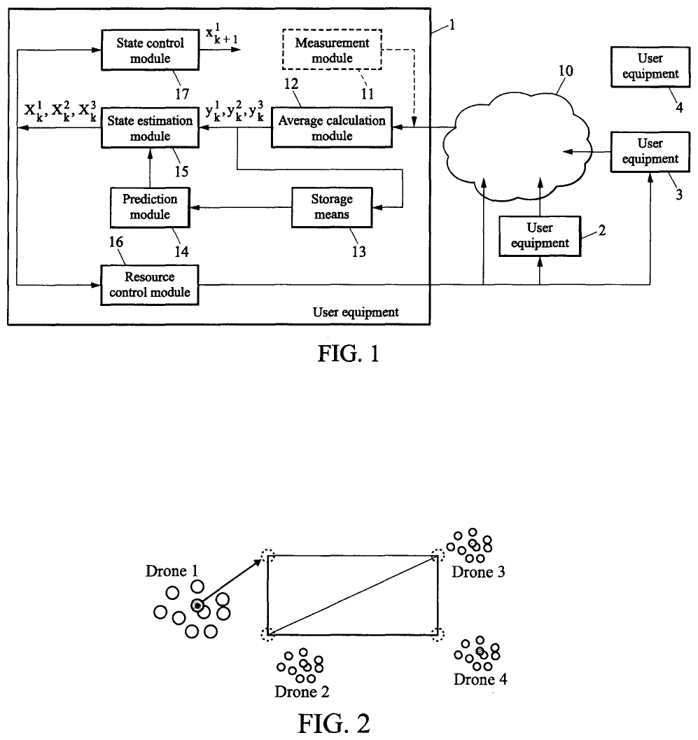

For clarity sake of the following detailed description, same reference numbers which are indicated in different ones of the figures, including FIG. 1 already described, denote identical elements or elements with identical function.

The invention is now described for the particular application of controlling a set of unmanned aerial vehicles, commonly referred to as drones, so that they have desired relative in-flight positions. For such illustrating example, each drone constitutes a separate user equipment as introduced before, and the respective current in-flight position of each drone is its current state. The state of drone i at time k is thus denoted xix, where i is an integer index for identifying each drone separately from the others in the whole set.

However, the invention can be applied to many systems other than a drone set, the type of the user equipment depending on each system as well as the states to be considered for these user equipments.

FIG. 2 illustrates a simple system in which the respective in-flight positions of four drones are to be controlled, for example using distributed control. The drones are labelled with the reference numbers 1, 2, 3 and 4, corresponding to the integer index i as just introduced. For each drone i, the corresponding dark-filled circle indicates its true position at time xₖⁱ. The target of the distributed control that is implemented in the drone set is forming and maintaining a prescribed rectangular pattern with the relative positions of the drones 1-4, as an illustrating but not-limiting example.

Each drone i may be provided on-board with its own GPS receiver which constitutes the measurement module for this drone i, GPS standing for “Global Positioning System”, but any other positioning system may be used alternatively. Thus, for drone 1, its measurement module 11 is comprised of the GPS positioning receiver. Each drone i is thus capable in principle of collecting at least one basic measurement of its own position relating to any time k, and preferably several such measurements.

Each drone i may also be provided with communication means (not shown) which are designed for communicating with the other drones. The communication means may then be part of the resources 10, in addition to the measurement modules 11. These resources 10 may also include other communication components, such as a centre node or master node, and they may be at least partly of wireless type, in particular of radio type. Thus, each drone can transmit the basic measurements of its own position as provided by its GPS receiver, to at least some of the other drones of the set.

Other systems may be used alternatively for measuring the positions of the drones. For example, each drone i may be provided on-board with appropriate means for measuring the respective positions of at least some of the other drones. Still another possibility is that each drone i receives wirelessly the respective position measurements of at least some of the other drones from an external position measuring system. One will understand that the invention applies whatever the actual measurement means and communication mode which are used for providing at least one of the drones with the necessary position measurements.

The description is now continued for drone 1, assuming that drone 1 does not receive the position measurements of drone 4, but only those of drones 2 and 3. Drones 1, 2 and 3 thus form a subset within the whole drone set, which is used for implementing the control within drone 1. Let j be an integer index that identifies the drones of this subset, i.e. j=1, 2 or 3. The basic position measurements relating to time k and drone j, when they are plural, are averaged by the average calculation module 12 for issuing a resulting position measurement which relates again to time k and drone j, and which is yₖ^{j}. When only one basic position measurement is collected for time k and drone j, it constitutes directly the position measurement yₖ^{j}. Also possibly no basic measurement may be collected for time k and drone j. Due to measurement errors and noise, each position measurement yₖ^{j} may be different from the corresponding true position xⱼ^{k}. In FIG. 2, the position measurements are represented as emptied circles for each drone i, and each dotted-line circle represents its target relative position with respect to the other drones.

The basic position measurements of drone 1 may be provided internally by the GPS receiver 11 and also averaged by the average calculation module 12 of drone 1 to provide the position measurements yₖ¹. However, it is not compulsory that drone 1 uses its own position measurements, and it may use the position measurements of drones 2 and 3 only. We will consider below that the position measurements yₖ¹ of drone 1 are available for it, in addition to the position measurements y₂^{k} and yₖ³.

Let's assume that drone 1 has collected beforehand the position measurements of the drones 1, 2 and 3 for times k−1, k−2 . . . prior to time k, respectively denoted yₖ₋₁¹, yₖ₋₂¹ . . . , yₖ₋₁², yₖ₋₂² . . . and y₃₋₁^{k}, yₖ₋₂³ . . . . Here, k, k−1, k−2 . . . denote successive times at which drone 1 updates its position, leading to the true positions xₖ₊₁¹, xₖ¹, Xₖ₋₁¹ . . . Based on the prior position measurements yₖ₋₁¹, yₖ₋₂¹ . . . , yₖ₋₁², yₖ₋₂² . . . and yₖ₋₁², yₖ₋₂² . . . stored by the storage means 13, the prediction module 14 infers position predictions for time k respectively for the drones 1-3. Alternatively, the storage means 13 may store a statistical distribution for each drone j, which is obtained from the prior position measurements yₖ₋₁^{j}, yₖ₋₂^{j} . . . . Such statistical distribution may be transmitted by the state estimation module 15 to the storage means 13. The position predictions are inferred by the prediction module 14 using a prediction model which will be discussed later. The position measurements and position predictions relating to time k are all fed into the state estimation module 15 which combines them all together for issuing the respective position estimates Xₖ¹, Xₖ² and Xₖ³ of the drones 1-3 all relating to time k. The remainder of the operation of the control is unchanged with respect to the prior art already described.

The reliability of each of the position measurements yₖ^{j}, yₖ₋₁^{j}, yₖ₋₂^{j} . . . may be improved by increasing the number of the basic position measurements that relate to the drone j and the time of concern, and that are combined through averaging by the average calculation module 12. It may be therefore necessary that the frequency of collection of the basic position measurements is higher than the state update frequency. Adjusting the collection frequency of the basic position measurements involves configuration parameters of the drone set as measurement frequencies and transmission bandwidth. It is thus possible to increase the reliability of the position measurements yₖ^{j}, yₖ₋₁^{j}, yₖ₋₂^{j} . . . that are used for implementing the distributed control, but at the cost of increased resource requirement.

Another issue relates to the validity of the prediction model that is implemented by the prediction module 14. Indeed, this prediction model constitutes an assumption of the movements of the drones 1, 2 and 3, and provides the predictions of their positions for time k from their preceding positions. But this prediction model may be no longer valid for any reason such as a new external instruction command, an effect of at least one drone actuator, any interfering event, etc.

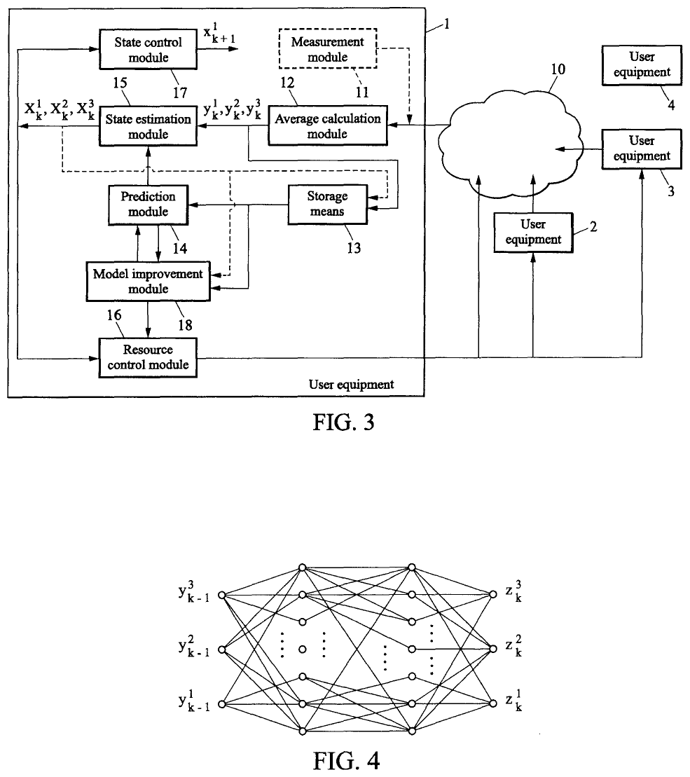

The operation of the whole control can be supported by equations derived from the well-known Bayesian framework. It combines the position measurements and position predictions for obtaining the updated position estimates Xₖ^{j}. This framework shows that the accuracy of the position estimates Xₖ^{j} strongly depends on the reliability of the measurements and predictions. As indicated above, the reliability of the measurements can be improved by increasing the frequency of the basic measurements that are inputted into the average calculation module 12 for at least some of the drones j. But an insufficient validity of the prediction model which is implemented by the prediction module 14 constitutes a weakness of the whole control. The invention improvement which is described below with reference to FIG. 3 is intended to reduce or cure this weakness.

As shown in FIG. 3, the control system that is on-board drone 1, and preferably also for the other drones, is completed with an additional module 18 called model improvement module. For this reason, drone 1 has been called model improvement user equipment in the general part of this description. Thus, the architecture of FIG. 1, known from prior art, and including the modules 11-17, is maintained but combined with the new module 18. This module 18 is designed according to the invention so as provide an improved trade-off between resource demand and prediction reliability. According to the invention, the model improvement module 18 is connected for receiving the position measurements yₖ^{j} from the storage means 13, in parallel with the prediction module 14, and for controlling the resource control module 16. Instead of being connected for receiving the position measurements yₖ^{j} from the storage means 13, the model improvement module 18 may alternatively be connected for receiving the position estimates Xix or statistics of the position measurements from the state estimation module 15, in parallel with the resource control module 16 and the state control module 17. The model improvement module 18 is also connected to the prediction module 14 for updating the prediction model that is actually implemented by this latter, and for monitoring an accuracy of the resulting position predictions. Most conveniently, the model improvement module 18 may be implemented as a software module.

The model improvement module 18 is designed for operating alternately in a training mode and an idle mode. The model improvement module 18 operates in either mode while the control continues being implemented as described before. The training mode is dedicated to issuing a new prediction model to be used next by the prediction module 14. This new prediction model will provide more accurate position predictions. Indeed, the training mode leads to updating the prediction model to be implemented by the prediction module 14, so as to take into account changes that may have occurred in the operation of the set of drones, for example external instruction commands or perturbations. At the end of each time period dedicated to the training mode, the updated prediction model is injected by the model improvement module 18 into the prediction module 14 so as to be used instead of the current one. The model improvement module 18 then switches to the idle mode, where it may monitor the validity of the prediction model as newly implemented by the prediction module 14, but not necessarily. Because the prediction model has been trained just before during the preceding time period dedicated to the training mode, its validity is more ensured, and the resulting position predictions are more accurate and reliable. During the next time period dedicated to the idle mode, the model improvement module 18 may check the validity of this prediction model by comparing each position measurement yₖ^{j} with the corresponding position prediction as issued by the prediction module 14.

In the training mode, a sufficient number of position measurements needs to be collected, so that the prediction model that is currently being trained by the model improvement module 18 is accurate enough. To this end, the model improvement module 18 forces the resource control module 16 in the training mode so that the basic position measurements are performed and transmitted at a high enough frequency. Conversely, during the idle mode, the requirement of high enough number of basic position measurements no longer holds, since the prediction model is accurate enough for estimating the position measurements. Thus, the demand in measurements and communication resources during the time period dedicated to the idle mode can be lowered. In particular, the frequency of the basic position measurements and of their transmission as controlled by the resource control module 16 can be lowered significantly with respect to the training mode. The transmission load of the communication resources is thus reduced, but almost no loss in the accuracy of the position estimates results from such reduction thanks to the reliability of the prediction model as provided by the training mode. This benefit of the invention applies in particular when the communication between the user equipments, i.e. the drones, is of radio type. A radio load reduction is then obtained thanks to the invention.

So during each time period dedicated to the training mode, the model improvement module 18 controls the resource control module 16 to get enough basic position measurements to train a new prediction model. The position measurements yₖ^{j}, yₖ₋₁^{j}, yₖ₋₂^{j} . . . obtained are then more reliable because of being based each on an increased number of basic position measurements. The cost for that is the resource requirement in the training mode for collecting the basic position measurements at a frequency that is high enough. This resource requirement is met during each training mode time period by forcing suitable configuration parameters of the drone set. The reliable position measurements yₖ^{j} which are thus collected for the drones 2 and 3 and internally within drone 1 for the exemplifying application of FIGS. 1 and 3, are used by the state estimation module 15 for obtaining more accurate position estimates Xₖ^{j}, and also used in parallel by the model improvement module 18 for training the new prediction model. At this time, the prediction module 14 still implements the prediction model which has been provided by the model improvement module 18 at the end of the preceding time period dedicated to training mode. During each time period dedicated to the training mode, the state estimation module 15 mostly relies on the position measurements, because these latter are sufficient in number and accuracy.

FIG. 4 illustrates the prediction model as being trained by the model improvement module 18 in the training mode. Such representation is common for the Man skilled in artificial intelligence. The inputs of the model are the position measurements yₖ₋₁^{j} of drones 1, 2 and 3 for the application example of FIG. 2, at at least one preceding time in the operation of the whole control system, i.e. k−1, as indicated in the left part of FIG. 4. Possibly, these position measurements yₖ₋₁^{j} may be replaced by the position estimates Xₓ₋₁^{j} issued for the drones 1, 2 and 3 and for time k−1, or by the related statistical distributions. The outputs of the prediction model are the position predictions for these drones 1, 2 and 3 and for the next time, i.e. k, as denoted by z′ in the right part of the figure. The labels used for the training are the position measurements obtained for time k: yₖ¹, yₖ² and yₖ³. In different embodiments of the invention, the prediction model may deal with the drones j all together, or it may be comprised of individual prediction models that relate separately and respectively to the drones j.

The end of each training mode period may be triggered in different ways. A first way is that a criterion is met by the prediction model currently trained, meaning that this trained prediction model provides sufficient consistency between the position predictions zₖ^{j} and the position measurements yₖ^{j}. Such criterion has been called matching criterion of the training mode in the general part of this description. For example, a criterion such as the following one may be implemented: the norm ∥yₖ^{j}−zₖ^{j}∥ is inferior to a predefined threshold value for several succeeding times k. Another possibility for stopping the training mode period is that drone 1 has received a request for available resources from any other element of the system, including from one of the other drones. Such request may be issued because another function implemented in the drone set requires sufficient communication bandwidth. Still another possibility for stopping the training mode period may be a command issued by a scheduling algorithm. Such scheduling algorithm may be dedicated to distributing the communication resources between various functions of the drone set, whatever these functions, based on assignment rules and respective resource requirements of the functions. At the end of the training mode period, the new prediction model just trained is injected into the prediction module 14, for replacing the previous one. The prediction module 14 then operates using this new prediction model, and the model improvement module 18 switches to the idle mode.

During the idle mode time period, the model improvement module 18 may check continuously the validity of the prediction model that is currently implemented by the prediction module 14. To this purpose, the model improvement module 18 compares the position predictions as resulting from the prediction model currently implemented by the prediction module 14 with the position measurements, i.e. yₖ¹, yₖ² and yₖ³. The operation of the control during the idle mode time period may be fed with a reduced number of basic position measurements, since the prediction model used is of improved validity. Thanks to this, the idle mode is less demanding in measurement and communication resources than the training mode, so that an increased amount of the resources may be assigned to functions other than the distributed control. In particular, the frequency of the basic position measurements which are performed for each drone and their transmission between the drones is set by the model improvement module 18, through the resource control module 16, at higher values in the training mode compared to the values of this frequency as effective in the idle mode. The idle mode time period may be continued until a matching criterion is no longer met between the position measurements yₖ^{j} and the position predictions as issued by the prediction module 14. This matching criterion for the idle mode may be similar to that of the training mode, but not necessarily. Alternatively, the idle mode time period may be continued until drone 1 receives an indication that an amount of resources is available, or until a switching order is issued by the scheduling algorithm. The model improvement module 18 then switches back to the training mode. It is also possible that the model improvement module 18 in the idle mode assesses continually a reliability of the position measurements yₖ^{j} and switches into the training mode when it determines that this reliability is good enough for allowing training a new prediction model. Such switch triggering may be promoted by increasing the frequency of the basic position measurements when possible in the idle mode. It is also possible again that in the idle mode, the model improvement module 18 requires to increase temporarily the frequency of the basic position measurements for obtaining resulting measurements with improved reliability.

The invention is not limited to the field of controlling a set of drones, and may be applied advantageously to many other systems comprised of a plurality of user equipments. The number of the user equipments in the system as well as the number of these equipments that are actually used within one user equipment as the subset for implementing the distributed control may be any. It is thus clear that the numbers of four for the user equipments in the system, and three for the user equipments in the subset are not limiting but have been used only for exemplifying purpose.

1. A user equipment, adapted for implementing a control in a set of user equipments, where said user equipment updates its own state based on state measurements and state predictions obtained for a subset of the user equipments,
wherein said user equipment comprises:
storage means, adapted for storing at least some of the state measurements obtained for each user equipment of the subset, or for storing statistics that are derived from said state measurements obtained for each user equipment of the subset;
a prediction module, adapted for inferring a state prediction for any of the user equipments of the subset, by implementing a prediction model with state measurements or statistics recovered from the storage means;
a state estimation module, adapted for issuing a state estimate for each of the user equipments of the subset, by combining the state measurements and the state predictions of said user equipments of the subset;
a resource control module, adapted for selecting configuration parameters intended to control an operation of resources of the user equipments based on the state estimates issued by the state estimation module; and
a state control module, adapted for updating the state of the user equipment, also based on the state estimates issued by the state estimation module,
characterized in that said user equipment further comprises:
a model improvement module, adapted for implementing alternately a training mode and an idle mode,
wherein in the training mode, the model improvement module trains the prediction model to be implemented next by the prediction module, from the state measurements or statistics that are obtained for the user equipments of the subset or from the state estimates issued by the state estimation module,
the model improvement module being furthermore configured for injecting the prediction model as trained in the training mode into the prediction module, so that the prediction model injected by the model improvement module into the prediction module is used by said prediction module when said model improvement module is next in the idle mode, and the model improvement module is further adapted to control the resource control module for adjusting a reliability of the state measurements obtained for each user equipment of the subset at a level during a time period dedicated to the training mode higher than another level of said reliability that is effective during a prior or subsequent time period dedicated to the idle mode.

2. The user equipment of claim 1, wherein the model improvement module is further adapted to assess, during the time period dedicated to the idle mode, a validity of the prediction model which is currently implemented by the prediction module, as said prediction model has been previously trained by said model improvement module during the time period dedicated to the training mode.

3. The user equipment of claim 1, adapted so that, for any of the user equipments of the subset, each state measurement stored by the storage means or used by the state estimation module is obtained from one or several basic state measurements, and the model improvement module is further adapted to control the resource control module for adjusting a frequency of the basic state measurements that are obtained for each user equipment of the subset, so that a value of said frequency during the time period dedicated to the training mode is higher than another value of said frequency that is effective during the prior or subsequent time period dedicated to the idle mode.

4. The user equipment of claim 1, adapted so that the state of any of the user equipments of the subset comprises coordinate values of a position of said user equipment of the subset.

5. The user equipment of claim 3, adapted for operating with the basic state measurements being provided by at least one positioning system, and the basic state measurements for each user equipment of the subset are transmitted wirelessly between the user equipments or internally to each user equipment.

6. The user equipment of claim 1, wherein the model improvement module is adapted to switch from the training mode to the idle mode once a matching criterion of the training mode is met by the prediction model that is currently being trained, between the state measurements and the state predictions inferred using said prediction model that is currently being trained, or after a request to free some resources has been received by said user equipment, or at a time issued by a scheduling algorithm.

7. The user equipment of claim 1, wherein the model improvement module is adapted to switch back from the idle mode to the training mode when at least one of the following conditions occurs:
a matching criterion of the idle mode is no longer met between the state measurements and the state predictions as issued by the prediction module;
after receiving an indication that an amount of the resources is available;
after receiving an indication that the reliability of the state measurements is above a predetermined threshold; and
at a time issued by a scheduling algorithm.

8. The user equipment of claim 1, wherein the configuration parameters selected by the resource control module based on the state estimates issued by the state estimation module, and possibly also based on requirements from the state control module, are suitable for controlling at least one of a frequency of basic state measurements, a transmission frequency of said basic state measurements, modulation and coding schemes, and at least one transmission power implemented between the user equipments.

9. A process for implementing a control in a set of user equipments, where each user equipment updates its own state based on state measurements and state predictions obtained for a subset of the user equipments,
wherein at least one of the user equipments performs the following steps:
storing at least some of the state measurements obtained for each user equipment of the subset, or storing statistics derived from said state measurements obtained for each user equipment of the subset;
inferring a state prediction for any of the user equipments of the subset, by implementing a prediction model with state measurements or statistics which have been stored previously;
issuing a respective estimate for the state of each of the user equipments of the subset, by combining the state measurements and state predictions of said user equipments of the subset;
selecting configuration parameters intended to control an operation of resources of the user equipments based on the state estimates; and
updating a state of said user equipment also based on the state estimates, characterized in that at least one of the user equipments, referred to as model improvement user equipment, operates alternately in a training mode and an idle mode,
wherein in the training mode, the prediction model is trained from the state measurements or statistics that are obtained for each user equipment of the subset, or from the state estimates issued for each user equipment of the subset,
the process furthermore comprising updating the prediction model which is implemented for inferring the state predictions, according to the prediction model as trained in the training mode, and
wherein the configuration parameters are adjusted so that a reliability of the state measurements obtained for each user equipment of the subset is at a level during a time period dedicated to the training mode higher than another level of said reliability that is effective during a prior or subsequent time period dedicated to the idle mode.

10. The process of claim 9 wherein, in the idle mode, a validity of the prediction model which is currently implemented is assessed, as said prediction model has been previously trained during the time period dedicated to the training mode.

11. The process of claim 9 wherein, for any of the user equipments of the subset, each state measurement stored or used for issuing one of the state estimates is obtained from one or several basic state measurements,
and a frequency of the basic state measurements that are obtained for each user equipment of the subset is adjusted so that a value of said frequency during the time period dedicated to the training mode is higher than another value of said frequency that is effective during the prior or subsequent time period dedicated to the idle mode.

12. The process for implementing a control in a set of user equipments, where each user equipment updates its own state based on state measurements and state predictions obtained for a subset of the user equipments,
wherein at least one of the user equipments performs the following steps:
storing at least some of the state measurements obtained for each user equipment of the subset, or storing statistics derived from said state measurements obtained for each user equipment of the subset;
inferring a state prediction for any of the user equipments of the subset, by implementing a prediction model with state measurements or statistics which have been stored previously;
issuing a respective estimate for the state of each of the user equipments of the subset, by combining the state measurements and state predictions of said user equipments of the subset;
selecting configuration parameters intended to control an operation of resources of the user equipments based on the state estimates; and
updating a state of said user equipment also based on the state estimates, characterized in that at least one of the user equipments, referred to as model improvement user equipment, operates alternately in a training mode and an idle mode,
wherein in the training mode, the prediction model is trained from the state measurements or statistics that are obtained for each user equipment of the subset, or from the state estimates issued for each user equipment of the subset,
the process furthermore comprising updating the prediction model which is implemented for inferring the state predictions, according to the prediction model as trained in the training mode, and
wherein the configuration parameters are adjusted so that a reliability of the state measurements obtained for each user equipment of the subset is at a level during a time period dedicated to the training mode higher than another level of said reliability that is effective during a prior or subsequent time period dedicated to the idle mode, wherein the model improvement user equipment meets claim 1.

13. The process of claim 9, wherein the state of any of the user equipments of the subset comprises coordinate values of a position of said user equipment of the subset.

14. The process of claim 11, wherein the basic state measurements are provided by at least one positioning system, and the basic state measurements for each user equipment of the subset are transmitted to the model improvement user equipment wirelessly or internally to said model improvement user equipment.

15. The process of claim 9, wherein the model improvement user equipment switches from the training mode to the idle mode once a matching criterion of the training mode is met by the prediction model that is currently being trained, between the state measurements and the state predictions inferred using said prediction model that is currently being trained, or after a request to free some resources has been received by said model improvement user equipment, or at a time issued by a scheduling algorithm.

16. The process of claim 9, wherein the model improvement user equipment switches back from the idle mode to the training mode when at least one of the following conditions occurs:
a matching criterion of the idle mode is no longer met between the state measurements and the state predictions as used for issuing the state estimates;
after receiving an indication that an amount of the resources is available;
after receiving an indication that the reliability of the state measurements is above a predetermined threshold; and
at a time issued by a scheduling algorithm.

17. The process of claim 11, wherein the configuration parameters are selected based on the state estimates, and possibly also based on control requirements, for controlling at least one of a frequency of basic state measurements, a transmission frequency of said basic state measurements, modulation and coding schemes, and at least one transmission power implemented between the user equipments.

18. Set of user equipments adapted to implement a control, wherein at least one of said user equipments is in accordance with claim 1.
